(19) United States
(12) Patent Application Publication
(10) Pub. No.: US 2012/0072632 A1
(43) Pub. Date: Mar. 22, 2012

(54) Deterministic and non-Deterministic Execution in One Processor

(76) Inventor: Paul Kimelman, Alamo, CA (US)

(21) Appl. No.: 12/885,401

(22) Filed: Sep. 17, 2010

(51) Int. Cl. G06F 13/26

(52) U.S. Cl. 710/264; 711/125; 711/E12.057

(57) ABSTRACT

An application in a data processing system may automatically select when it needs determinism and when it does not. The ability to have the system automatically select when to use each allows optimum system performance while maintaining hard real-time requirements when needed.

### FIELD OF THE INVENTION

This invention generally relates to data processing systems for real-time applications and more particularly to dynamically configuring cache operation to provide optimum system performance while maintaining hard real-time requirements.

### BACKGROUND OF THE INVENTION

In modern computer processing systems that include microcontroller units (MCUs) and/or microprocessor units (MPUs), the maximum performance of the processor is normally limited by memory speeds and the pipeline of the processor. MCUs and MPUs may be used in embedded systems for controlling operation of a physical device. An MCU typically includes a central processing unit (CPU), non-volatile memory and various peripheral buffers in a self-contained package. In many MCU/MPU applications, hard real-time is a requirement, at least for part of the application. That is, the response to an external input must occur within a fixed period time. For example, for motor commutation, the time between the reading of the motor currents (or rotor position) and the change of the controls on the motor stator must occur in a very controlled way. If too much variability exists, then the stator output will be incorrect, as it would apply to a different rotor position because the rotor keeps moving. In another example, when live digitized audio (sound) data is input into an application, it must be processed within a very controlled period of time. The audio is a continuous, non-stop feed of data over time and any delays or change in timing may change the sound value by changing the pitch, causing clicks, etc.

When reading directly from memory, the processor will be deterministic. That is, it can be determined exactly how long it will take each time a same portion of an application is executed. Therefore, if a set of processor instructions (e.g., a function) must complete an operation in a fixed period of time, it is possible to determine if this will happen every single time when reading directly from memory. When reading from a cache, the processor will normally be non-deterministic. That is, the amount of time it will take will vary depending on recent history. So, for example, if a function were executed three times in a row, it will likely execute faster the second and third times because its instructions may be in the cache which is faster memory.

### BRIEF DESCRIPTION OF THE DRAWINGS

Embodiments of the invention will now be described, by way of example only, and with reference to the accompanying drawings:

FIG. 1 is a block diagram illustrating a exemplary system on a chip (SOC) with a cache that is automatically enabled and disabled;

FIGS. 2 and 5 are each a block diagram illustrating other embodiments of a system with a cache that is dynamically enabled and disabled;

FIG. 3 is a block diagram illustrating a reconfigurable cache;

FIG. 4 is a flow diagram illustrating automatic control of a cache to provide deterministic execution when needed; and

FIG. 6 is a flow diagram illustrating an embodiment of programmatic reconfiguration of the cache of FIG. 3 to provide deterministic execution when needed.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A processor that is directly connected to the system bus will be limited in speed by the bus and all of the components connected to it. To get around this limit, a number of techniques may by employed. Techniques related to memory transactions will be described herein. Other aspects of the system bus may also affect processor performance, for example: the operation and control of peripheral devices, such as communication ports, etc; loading on the system bus and drive capability of processor; timing and control of the system bus, such as clock speed or asynchronous operation; etc.

A major obstacle to processor performance is the speed with which it can read memory. Writing of memory has a smaller impact for two reasons: a write buffering technique may be used, and writing is performed less often than reading. A write buffer temporarily holds the data to be written until the memory becomes ready to take it, thereby allowing the processor to continue.

Reading of memory directly impacts the processor because the processor generally cannot continue execution until the data arrives. Therefore, it must wait for the data before it can continue execution. Further, since the processor must read instruction memory as well as data memory, the instruction memory is often the most limiting factor. To make matters more difficult, conditional instruction branching means that it is often not possible to tell which instruction memory location is needed until it is needed. Various embodiments of the invention may focus on instruction memory rather than data memory, although other embodiments may manipulate both instruction memory and data memory, as described in more detail below.

A common technique to improve the performance of reading memory is a cache. A cache is a type of fast memory that stores some values which are also stored in the main memory. There are many well known structures for caches, which will not be described in detail herein. The normal behavior of a cache is to remember the values that were read from slower memory, so that while slow when first read, any subsequent reads will be much faster. Since a cache has a finite amount of fast memory it can only hold a limited set of values, usually the most recently read ones Therefore, the performance will only be faster when a location is read multiple times in a short period of time. For the purposes of this description, it is assumed the cache will hold a large enough set of values from enough locations that it adds real improvement in speed. Typically, a cache will be able to hold a number of non-contiguous locations of memory. Caching only a set of contiguous locations of memory typically has less value for system performance, both for instruction memory and data memory. For instruction memory, branches (conditions, calls, returns, loops, etc.) form non-contiguous reads; for data memory, the accesses are naturally non-contiguous. Therefore, a cache will normally hold small groups of locations from different places based on where the processor reads memory.

While a cache is used to get best “average performance,” the resulting execution may exhibit a non-deterministic behavior. That is, if a function is executed three times in a row, the first time will typically be slow but the second and third times will be faster. Therefore, it will be faster on average over the three executions, but each time may require a different amount of execution time.

A typical cache will hold multiple lines of data or instructions along with a tag that identifies the address from where the current stored information came. A cache may have multiple sets of cache lines. However, there are also other forms of caches. For example, a branch cache stores only the value at the destination of a branch instruction. This can allow the cache time to reload while the processor executes the first instruction. Regardless of configuration, caches exhibit the property of non-deterministic behavior on normal applications. It should also be noted that many caches may have worse performance under certain conditions than direct access to memory, often referred to as a pathological case. This may result from cache thrashing, flushing of prior data that must be written to memory, or for other reasons.

There is another kind of buffering system which may give better performance than direct memory reads while still being deterministic. This kind of system is much like a small cache which only holds contiguous locations of memory. For example, if the memory is able to provide data 128 bits at a time, but the processor only needs 32 bits at a time, a read buffer may improve performance if that memory is slower than the processor. In such a system, a buffer of fast memory can capture the 128 bits when the processor reads a location. The 32 bits requested are delivered to the processor, albeit at the slower speed of the memory. However, when the processor needs another 32 bits within that same 128 bit region, usually the next location, the buffer memory can provide it quickly. This model is often known as read buffering. This method is deterministic because the behavior and timing is consistent from run to run since it does not depend on history other than the immediate instruction flow. Since determinism is about the time it takes the processor to execute the same sequence of instructions behaving the same way, this method does not change that. This same read buffering can be made better by adding one or more additional buffers that are used contiguously with the first. Keeping the buffers contiguous is required to ensure determinism. Further, one buffer can speculatively read ahead in the anticipation of the processor needing the next 128 bits (or whatever size is implemented in various embodiments). This is still deterministic, since the buffer will do this every time based on the same local information. However, a read buffering scheme will not be as fast as a cache in most cases. That is, it is trading off determinism for good average performance, but not best average performance. On the other hand, a direct coupling to slower memory will typically offer worse average performance.

Embodiments of the invention provide a data processing system in which an application may select when it needs determinism and when it does not. The ability to have the system dynamically select when to use each allows optimum system performance while maintaining hard real-time requirements when needed.

In some embodiments of the present invention, a processor reads its instructions from a flash memory. A flash memory is a special non-volatile memory; that is, it does not lose its contents when the power is shut off. An aspect of flash memory is that it is often more limited in speed than conventional static or dynamic random access memory (RAM).

In many MCU or MPU applications such as embedded control applications, hard real-time is a requirement, at least for part of the application. That is, the response to an external input must occur within a fixed period time. For example, for motor commutation the time between the reading of the motor currents (or rotor position) and the change of the controls on the motor stator must occur in a very controlled way. If too much variability exists, then the stator output may be incorrect because it would apply to a different rotor position since the rotor keeps moving. In another example, when live digitized audio (sound) data is input into an application, it must process it within a very controlled period of time. The audio is a continuous (non-stop) feed of data over time and any delays or change in timing may change the sound value by changing the pitch, cause clicks, etc. For these portions of the application, execution time determinism is required.

On the other hand, other parts of such applications may not need hard real-time, and may prefer the best average performance of a cache based system. For example, the motor application may be communicating over a network, which is a real-time but not a hard real-time requirement, and therefore can tolerate more variability in timing. Likewise, the audio application may have buttons and a display for interacting with a person which does not have a hard real-time or even real-time requirement. The CPU may also be executing other processes or other applications in addition to the real-time control application that prefer the best average performance of a cache based system.

In embodiments of the present invention, the read buffering model may be used to ensure fast deterministic behavior for slower flash. However, since some parts of the application do not need deterministic (hard real-time) behavior, caching may be enabled when deterministic behavior is not required. In various embodiments, caching may be implemented by adding more read buffers, which can operate on non-contiguous locations; by providing a single or multi-set associative cache, by providing a branch cache, or by providing any of the many options of caching now known or later developed. Although it could simply allow the application to choose which method to use, perhaps selected at reset time or perhaps changeable at various times, this would be very hard to manage and verify. Therefore, embodiments of the present invention offer a mechanism to allow the system to choose which method to use based on context of the application and processor according to pre-set rules.

For example, an application may be configured to run interrupt service routines deterministically, and to run basic code non-deterministically. A further refinement may be to run only particular interrupt service routine or set of interrupt service routines deterministically, based on their priority. Similarly, another refinement maybe to run only a particular interrupt service routine or set of interrupt service routines based on a selected or identified set of interrupt signal lines. This method ensures hard real-time where it is needed while getting maximum performance everywhere else. Because the system enforces this based on the pre-set rules, the application does not have to worry about corner cases that may have missed during system design/testing.

An interrupt service routine is how a processor breaks from what it is doing to service a real-time or hard real-time need. Interrupts are a way that an external device or timer, for example, may signal the application that it needs to do something else. In the example of a motor control task, an interrupt may be signaling that new rotor data is available and so updated stator commands are required immediately. In the example of an audio feed, it may indicate that another group (frame) of audio is available to be processed, or that it needs to emit another group (frame) of audio.

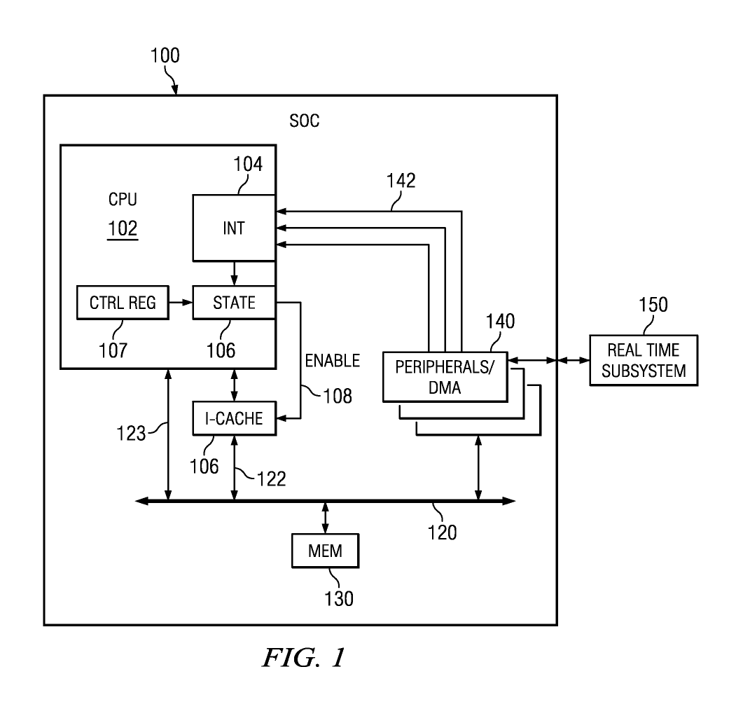

FIG. 1 is a block diagram illustrating an exemplary application specific integrated circuit system on a chip (SOC) 100 with CPU 102 coupled to an instruction cache 110 that is automatically switched between being enabled and being disabled based on the operation context of CPU 102 and one or more pre-set rules. For purposes of this disclosure, the somewhat generic term “microcontroller” (MCU) is used to apply to any complex digital system on a chip (SOC) that may include one or more processing modules 102, memory 130, and peripherals and/or DMA (direct memory access) controllers 140. At least a portion of memory module 130 may be non-volatile and hold instruction programs that are executed by processing module(s) 102 to perform the system applications. At least a portion of memory 130 has a slower access time than the CPU access rate, such that the I-cache 110 provides improved memory access performance. CPU 102 may also coupled to a data cache, not shown. Cache 110 is coupled to system bus 120 for access to bulk memory 130. Peripherals 140 are also coupled to system bus 120 to allow access and control by CPU 102.

The topology and configuration of SOC 100 is strictly intended as an example. Other embodiments of the invention may involve various configurations of buses for interconnecting various combinations of memory modules, various combinations of peripheral modules, multiple processors, etc. In some embodiments, CPU 102 may have a direct connection 123 to the system bus for use when the cache is disabled, while in other embodiments, the CPU may access the system bus via a path through the cache when the cache is disabled.

CPU 102 may be any one of the various types of microprocessors or microcontrollers that are now known or later developed. For example, CPU 102 may be a digital signal processor, a conventional processor, or a reduced instruction set processor. As used herein, the term “microprocessor” or CPU is intended to refer to any processor that is included within a system on a chip.

SOC 100 is coupled to real time subsystem (RTS) 150. RTS 150 may be a motor, for example, in which case SOC 100 controls motor speed and direction by controlling the application of voltage to multiple sets of stator windings based on rotor position. In another example, RTS 150 may be a speaker for playing audio sound or music that is converted from a digital stream by SOC 100. For the purpose of the description herein, RTS 150 is any type of device or component now known or later developed that requires some form of hard real-time control.

One or more of the peripheral devices 140 may provide control signals or data signals to RTS 150 and may receive status or other information from RTS 150. For example, if RTS 150 is a motor, peripheral device 140 may receive rotor position data from RTS 150 that generates an interrupt for a new stator control setting. As another example, if RTS 150 is a speaker, peripheral device 140 may provide an analog sound signal to RTS 150. Another peripheral module may be accessing a digital stream of audio data and generate an interrupt when a new frame of audio data is available. SOC 100 may be part of a mobile handset and be receiving voice and music digital signals via a cellular telephone network, for example.

In this embodiment of the invention, a control register 107 is provided which allows selection of the criteria for when to use caching and when not to use caching. This register may allow four possible states, although more or less could be offered in other embodiments. The four states may be: run the whole application non-deterministically (cached); run the whole application deterministically; run the base application non-deterministically but interrupt service routines deterministically; and, run the base application and lower priority interrupt service routines non-deterministically but run higher priority interrupt service routines deterministically. This method allows flexibility for the application, and ease of implementation and enforcement by the hardware.

For the present embodiment, the knowledge that an interrupt service routine is being entered or exited is provided by interrupt controller 104 that is part of CPU 102. Interrupt controller 104 receives one or more interrupt signals 142 from various sources, such as peripheral devices 140, timers, or other modules (not shown) within SOC 100. Further, interrupt controller 104 indicates the priority level of an interrupt that is being serviced by CPU 102. This provides all of the knowledge that is needed by the hardware to dynamically control enabling of I-cache 110 and is available in a timely manner. State detection logic 106 receives the interrupt and priority level information from interrupt controller 104, and also receives the application selected caching criteria from control register 107 and then generates cache enable signal 108 as defined by the operating mode and interrupt activity. Cache enable signal 108 controls I-cache 110 so that caching may be enabled or disabled automatically in response to an interrupt of a certain priority level. In this embodiment, when I-cache 110 is disabled, CPU 102 accesses instructions directly from main memory 130 via bypass path 123. In another embodiment, bypass path 123 may be included within the I-cache.

In some embodiments, a data cache (D-cache) may also be controlled by enable signal 108 so that data accesses are made directly to memory 130 during deterministic execution. In this case, there may be an additional bypass path for data accesses or the bypass path may be included within the D-cache. However, as discussed above, data accesses are generally not a significant factor in execution time determinism.

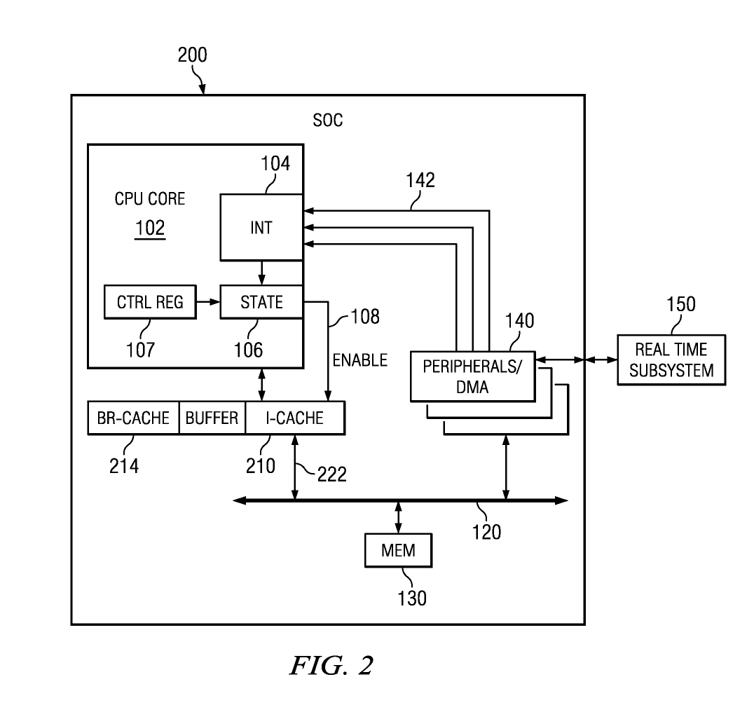

FIG. 2 is a block diagram illustrating another embodiment of a system 200 with a cache 210 that is automatically switched between being enabled and being disabled to provide deterministic operation on an as-needed basis. In this case, cache 210 may be dynamically reconfigured to act as a read buffer to provide deterministic execution. This read buffer as cache model works by having a large set of read buffers. When acting like a cache, the read buffers may still act like a read buffer. That is, when processor 102 tries to read a location, a read buffer is used to hold the extra data (for example, 64 bits or 128 bits). To operate as a cache, the read buffers do not have to be contiguous. So, when a location is read by the processor that is not held by any read buffer, the least recently used read buffer is reused (its old data is discarded). For example, if there are eight read buffers, then when the processor reads from one of the last eight location areas (for example 128 bits), it will get it from fast memory. However, the access will not be deterministic since it is heavily influenced by recent history. Similar behavior will occur from branch caching.

For deterministic operation, cache 210 is reconfigured so that only two read buffers will be used, and they will only hold contiguous locations. As mentioned earlier, the cache controller may cause a speculative read to fill the second buffer from a contiguous location. The other read buffers will continue to hold their current data. In some embodiments, the two least recently used buffers may be used during deterministic operation. In other embodiments, a designated same two read buffers may always be used during deterministic operation. The number of read buffers that are used during deterministic operation may be different from two in various other embodiments.

When exiting back to non-deterministic parts of the application, the read buffers will return to cache-like operation, with their present contents. The two buffers used for the interrupt service routines will continue to be considered the least recently used, and thus will be reused first. This is useful because their contents will be from the interrupt service routine and so unlikely to be of value to the non-deterministic portion of the application.

In some embodiments, I-cache 210 may also include a separate branch cache (BR-cache) portion 214. BR-cache 214 may be disabled under control of enable signal 108 during deterministic operation and then enabled by enable signal 108 during non-deterministic operation.

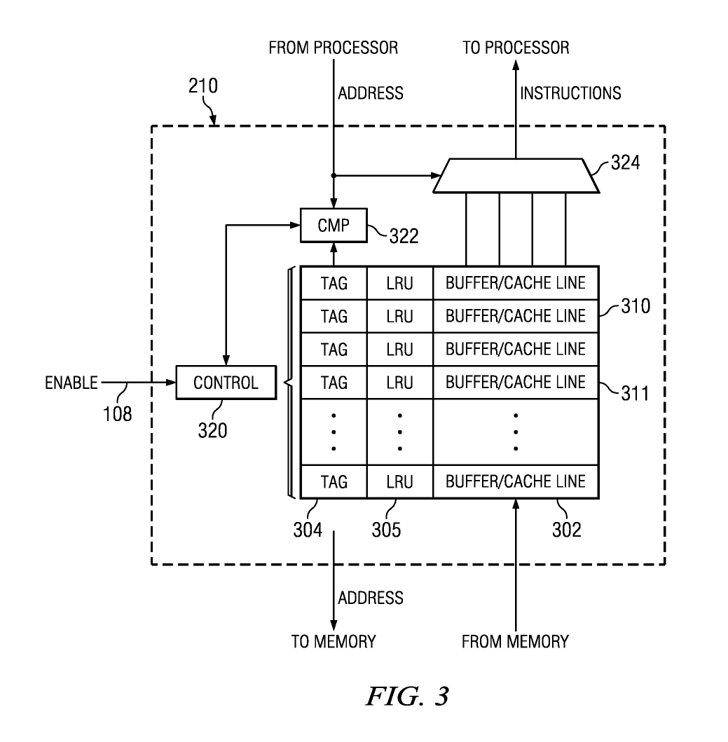

FIG. 3 is a block diagram illustrating the reconfigurable cache 210 in more detail. Cache 210 is implemented with a set of buffer/cache lines 302. The number of cache lines may vary in different embodiments. In the example described above, there are eight cache lines 302. Each cache line includes a tag portion 304 that includes the most significant portion of the address from which the current contents of the cache line was fetched. Each cache line also includes a least recently used (LRU) portion 305 that operates essentially as a counter to keep track of how long it has been since the current contents of the cache line were accessed by the processor. Control module 320 controls the operation of the cache. Address comparison module 322 compares the address of an access request from the processor with the contents of tags 304. When there is a match, the matching line contains the instruction requested by the processor. Least significant bits of the address are used to control multiplexer 324 in order to provide the requested instruction from the selected cache line. In this embodiment, each line holds 128 bits from memory, but the processor only fetches a 32 bit word. In alternate embodiments, the LRU may be optional, and any cache design may be used, such as random replacement, associative vs. non-associative, small set vs. large set, etc.

For non-deterministic operation, all lines of the cache are used, as directed by control module 320 in response to enable signal 108. In this mode of operation, the cache operates as a typical cache and non-contiguous portions of instruction sequences are fetched into the cache as the processor makes access requests. When a cache miss occurs, another line is fetched from memory and stored in the least recently used cache line, as indicated by LRU field 305.

When enable signal 108 is changed to indicate deterministic operation, the normal cache operation is disabled and the cache is reconfigured to operate as a simple read buffer. The two least recently used cache lines are then designated as read buffers and the remaining cache lines are not used. However, these remaining cache lines retain their data because after the real time interrupt process is complete, the non-deterministic instruction execution will return to where it was prior to the interrupt and the most recently used instructions saved in the cache may again be accessed.

For example, when a real-time interrupt occurs and deterministic execution is needed, enable signal 108 is de-asserted. Control module 320 then identifies the two least recently used cache lines. In this example, cache lines 310 and 311 are the two least recently used lines. These two lines are then marked as empty. In response to the next instruction fetch from the processor, controller 320 requests a line of instructions from the memory and places it in buffer lines 310 and sets the tag accordingly. As the processor accesses instructions, they are provided, until a miss occurs. The second line may be loaded with the next contiguous location from memory based on static decisions, such as branch information from the CPU. Once a miss occurs, another line is accessed and the process continues.

When exiting back to non-deterministic parts of the application, the read buffers will return to cache-like operation, with their present values. The two buffers used for the interrupt service routines will continue to be considered the least recently used, so will be reused first. This is useful because their contents will be from the interrupt service routine and so highly unlikely to be of value to the non-deterministic portion of the application.

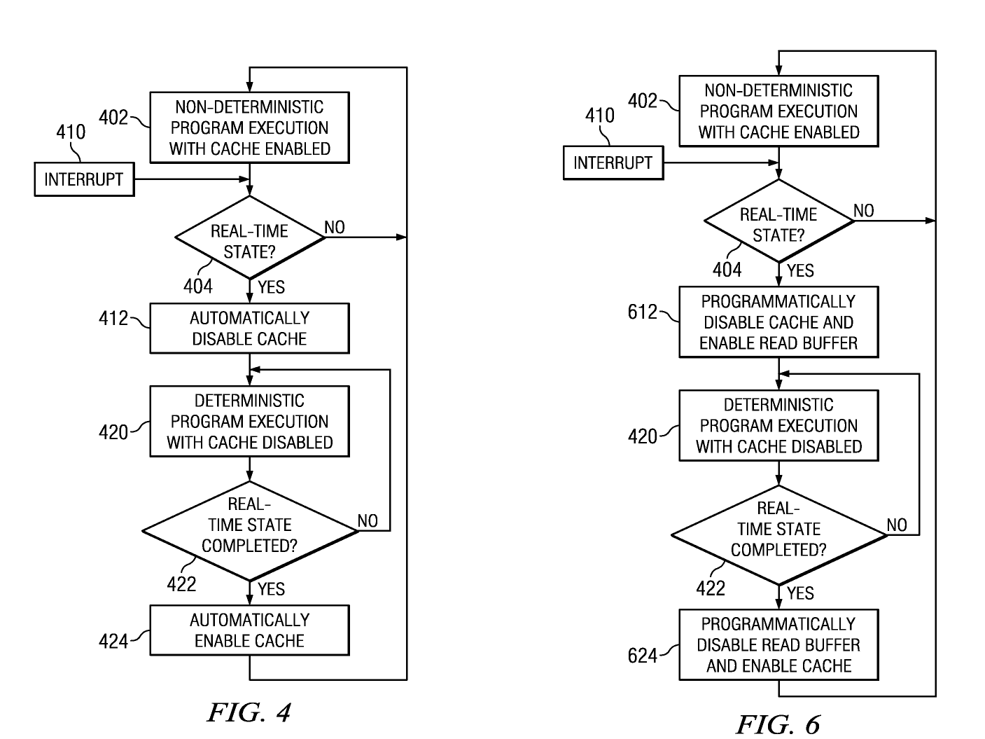

FIG. 4 is a flow diagram illustrating automatic control of a cache to provide deterministic execution when needed. Non-deterministic program execution is performed 402 while the instruction cache is enabled. At this point, the instruction cache operates as a typical cache.

At some point, an interrupt 410 is received that may indicate deterministic program execution is needed. Control logic determines 404 if a deterministic execution state is to be entered. This may be based on one or more pre-set rules or conditions. For example, if the priority of the interrupt is at or above a certain value, and if there is a control register that is set to allow deterministic program execution. If all conditions are met, then the control logic automatically disables 412 cache operation so that no overt action is needed by the application being executed. This is performed in a dynamic manner by the control logic while the application continues to execute. If all conditions are not met 404 to enter a deterministic execution state, execution continues 402 in a non-deterministic manner with the cache enabled. A traditional style cache may be disabled by simply inhibiting detection of cache hits so that all instruction memory accesses are forced to access main memory. Alternatively, a reconfigurable cache such as that described with regard to FIG. 3 may be configured to operate in buffer mode for deterministic execution.

Deterministic program execution proceeds 420 with the cache disabled. An interrupt service routine is executed 420 in response to the interrupt 410. Once the interrupt service routine is complete, a determination 422 is made that the real-time state is completed, and the cache is automatically enabled 424. Non-deterministic program execution 402 is resumed with the cache enabled. A traditional style cache may be enabled by simply allowing detection of cache hits. Alternatively, a reconfigurable cache such as that described with regard to FIG. 3 may be configured to operate in cache mode for non-deterministic execution.

In this manner, a data processing system is provided in which an application may automatically select when it needs determinism and when it does not based on pre-set rules without overt action from the application. The ability to have the system dynamically select when to use each mode of execution allows optimum system performance while maintaining hard real-time requirements when needed.

FIG. 5 is a block diagram illustrating another embodiment of a system 500 with a cache that is dynamically switched between being enabled and being disabled. In this embodiment, the reconfigurable cache of FIG. 3 is controlled overtly by an application executing on CPU 102. In this case, a control signal from a general purpose input/output bit 550 that can be controlled by software is used as enable signal 508 to control the reconfiguration of cache/buffer 210.

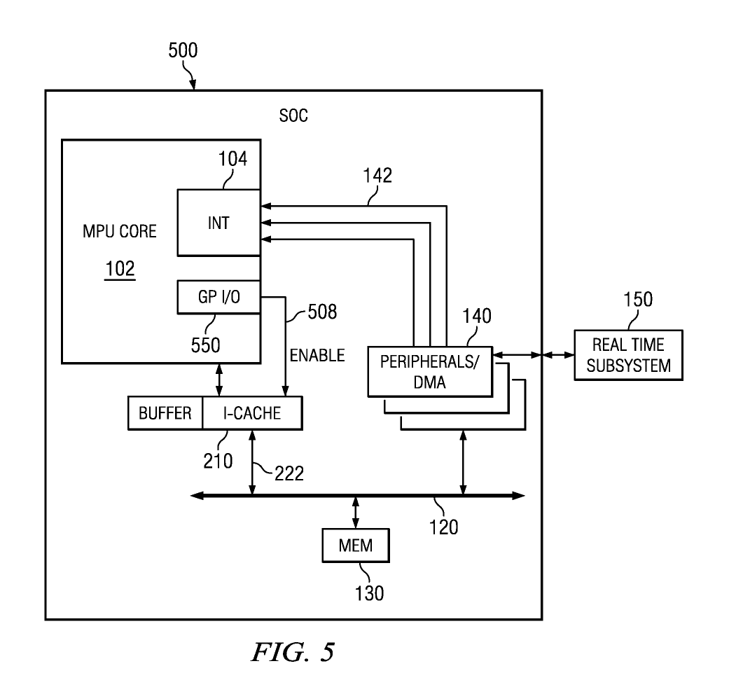

FIG. 6 is a flow diagram illustrating an embodiment in which reconfiguration of the cache of FIG. 3 is performed under program control to provide deterministic execution when needed. In this case, the operation is similar to that described with respect to FIG. 4, except that instead of automatically detecting a real-time state and automatically reconfiguring the cache, the reconfiguration is controlled by the application. For example, when a real-time state is entered 404, such as in response to interrupt 410, an instruction in the interrupt service routine 612 may set a bit to cause the cache to be reconfigured from cache mode to read buffer mode. Similarly, when the instruction service routine is complete, an instruction may be executed 624 to reset the bit to reconfigure the cache from read buffer mode back to cache mode.

### Other Embodiments

Although the invention finds particular application digital systems that may include Digital Signal Processors (DSPs) or MCUs implemented, for example, in an Application Specific Integrated Circuit (ASIC), it also finds application to other forms of processors. An ASIC may contain one or more megacells which each include custom designed functional circuits combined with pre-designed functional circuits provided by a design library. An ASIC may contain one or more processor cores each having an associated cache that is controlled as described herein.

While the invention has been described with reference to illustrative embodiments, this description is not intended to be construed in a limiting sense. Various other embodiments of the invention will be apparent to persons skilled in the art upon reference to this description. For example, while various types of caches have been described, embodiments of the invention are not limited to any particular type of cache.

Embodiments of the invention may switch automatically from non-deterministic to deterministic execution based on one or more pre-set rules that is used by a state detection logic module that monitors various signals within the processor or SOC. For example, occurrence of a particular interrupt signal or set of signals, or occurrence of an interrupt having a particular priority level or having a priority level above a certain value, as described herein. Other embodiments may change from non-deterministic to deterministic execution based on executing at a particular task priority, real-time task vs. non-real-time task, for example, or based on another system operating parameter that can be detected by a logic function within the system, such as: a task style such as privileged versus user, a process ID, detection of a particular fault, etc. In each case, one or more of the pre-set rules specify a selected characteristic of a task that is detectable by the state detection logic when the task is being executed.

A more extensive mechanism could certainly be used, for example: a timer nearly counted down (deadline), execution from certain locations (address match), etc. Similarly in these cases, a pre-set rule is established and a state detection logic module is employed to monitor the condition and to cause automatic enabling/disabling of the cache accordingly.

The dynamic mode switching behavior may be related to data made known to the system separately from the dynamic switching. For example, a task scheduler may load a specified task priority into a system register, but the effect of it would not occur until and unless a task having the specified priority is actually running. Once the specified task is being executed, then the operating mode of the cache would be automatically switched.

In many embodiments, the device would be in a package such as BGA and mounted to a printed circuit board. For harsh environments, such as industrial applications, the device is designed with sufficient tolerance and manufactured in such a manner that the system can operate correctly over a temperature range and shock and vibration range required for working around motors or other motion actuators. For such applications, the on-chip peripheral devices may take analog readings and provide PWM control for motion control. The peripheral devices are controlled by a processor that is able to automatically switch from non-deterministic execution to deterministic execution as required for real-time needs, as describe in more detail above.

An ASIC embodying the invention may be included in a control module for controlling operation of an automobile, an airplane, industrial processing equipment, medical equipment, etc.

As used herein, the terms “applied,” “coupled,” “connected,” and “connection” mean electrically connected, including where additional elements may be in the electrical connection path. “Associated” means a controlling relationship, such as a memory resource that is controlled by an associated port.

It is therefore contemplated that the appended claims will cover any such modifications of the embodiments as fall within the true scope and spirit of the invention.

What is claimed is:

1. A method for operating a digital system having a processor and a memory configured to store instructions for an application, the method comprising:
determining when a cache should be enabled and disabled during execution of the instructions by the processor;
automatically disabling cache operation in response to each determination that the cache should be disabled; and
automatically enabling cache operation in response to each determination that the cache should be enabled.

2. The method of claim 1, wherein determining if a cache should be enabled or disabled is based on one or more pre-set rules.

3. The method of claim 1, wherein disabling cache operation comprises reconfiguring at least of a portion of the cache to operate as a read buffer; and wherein enabling cache operation comprises reconfiguring the read buffer to operate again as a cache.

4. The method of claim 1, wherein disabling cache operation causes all instruction fetches by the processor to access the memory.

5. The method of claim 2, wherein one of the pre-set rules is the cache should be disabled while executing an interrupt service routine.

6. The method of claim 5, wherein the interrupt service routine must be for a particular interrupt or set of interrupts.

7. The method of claim 5, wherein the interrupt service routine must be for an interrupt having a priority level above a certain value.

8. The method of claim 2, wherein one of the preset rules specifies a task priority.

9. The method of claim 8, wherein a task having a specified task priority is scheduled, but the rule is not met until a task having the specified priority is being executed.

10. The method of claim 2, wherein one or more of the preset rules specify a selected characteristic of a task that is detectable when the task is being executed.

11. A method for operating a digital system having a processor and a memory configured to store instructions for an application, the method comprising:
determining when a cache should be enabled and disabled during execution of the instructions by the processor;
programmatically disabling cache operation each time it is determined the cache should be disabled, wherein disabling cache operation comprises reconfiguring at least of a portion of the cache to operate as a read buffer; and
programmatically enabling cache operation each time it is determined the cache should be enabled, wherein enabling cache operation comprises reconfiguring the read buffer to operate again as a cache.

12. A system comprising an integrated circuit, wherein the integrated circuit comprises:
a memory module operable to store instructions;
at least one processor coupled to execute instructions stored in the memory module;
a cache coupled to the processor and to the memory module;
state detection logic coupled to the processor, wherein the state detection logic is configured to determine when the processor is executing in a real-time state; and
wherein the cache is configured to be disabled in response to a control signal from the state detection logic while the processor is executing in the real-time state.

13. The system of claim 12, wherein the state detection logic determines when the processor is executing in a real-time state based on one or more pre-set rules.

14. The system of claim 12, wherein the cache is configurable to operate as a read buffer while it is disabled.

15. The system of claim 12, wherein the state detection logic is configured to determine the processor is executing in a real-time state when the processor is executing an interrupt service routine.

16. The system of claim 12, wherein the state detection logic is configured to determine the processor is executing in a real-time state when the processor is executing an interrupt service routine having a priority level above a certain value.

17. The system of claim 12, wherein the state detection logic is configured to determine the processor is executing in a real-time state when the processor is executing a task having a certain priority.

18. The system of claim 12, further comprising a peripheral module coupled to the at least one processor; and an actuator coupled to receive one or more motion control signals from the peripheral module, wherein the motion control signals are responsive to execution of the instructions in the memory module.

19. The digital system of claim 12 being a cellular mobile handset.
